(19) United States
(12) Patent Application Publication
(10) Pub. No.: US 2005/0232463 A1
(43) Pub. Date: Oct. 20, 2005

(54) Method and apparatus for detecting a presence prior to collision

(76) Inventors: David Hirvonen, Portland, OR (US); Theodore Armand Camus, Marlton, NJ (US); John Benjamin Southall, Philadelphia, PA (US); Robert Mandelbaum, Bala Cynwyd, PA (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 11/070,356

(22) Filed: Mar. 2, 2005

Related U.S. Application Data
(60) Provisional application No. 60/549,186, filed on Mar. 2, 2004.

(51) Int. Cl. G06K 9/00

(52) U.S. Cl. 382/103; 382/154

(57) ABSTRACT

A method and apparatus for detecting a target in an image is disclosed. A plurality of depth images is provided. A plurality of target templates is compared to at least one of the plurality of depth images. A scores image is generated based on the plurality of target templates and the at least one depth image.

### CROSS-REFERENCE TO RELATED APPLICATIONS

This application claims the benefit of U.S. provisional patent application No. 60/549,186 filed, Mar. 2, 2004, which is herein incorporated by reference.

### BACKGROUND OF THE INVENTION

1. Field of the Invention

The present invention relates to artificial or computer vision systems, e.g. vehicular vision systems. In particular, this invention relates to a method and apparatus for detecting objects in a manner that facilitates collision avoidance.

2. Description of the Related Art

Collision avoidance systems utilize a sensor system for detecting objects in front of an automobile or other form of vehicle or platform. In general, a platform can be any of a wide range of bases, including a boat, a plane, an elevator, or even a stationary dock or floor. The sensor system may include radar, an infrared sensor, or another detector. In any event the sensor system generates a rudimentary image of the scene in front of the vehicle. By processing that imagery, objects can be detected. Collision avoidance systems generally use multiple resolution disparity images in conjunction with one depth image. A multiple resolution disparity image may have points that correspond to different resolution levels. Thus, the depth image generated may not correspond smoothly with each multiple resolution disparity image.

Therefore, there is a need in the art for a method and apparatus that provides depth images at multiple resolutions.

### SUMMARY OF THE INVENTION

The present invention describes a method and apparatus for detecting a target in an image. In one embodiment, a plurality of depth images is provided. A plurality of target templates is compared to at least one of the plurality of depth images. A scores image is generated based on the plurality of target templates and the at least one depth image.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts one embodiment of a schematic view of a vehicle utilizing the present invention;

FIG. 2 depicts a block diagram of a vehicular vision system in accordance with one embodiment of the present invention;

FIG. 3 depicts a block diagram of functional modules of the vision system of FIG. 2 in accordance with one embodiment of the present invention; and

FIG. 4 illustrates a flow diagram in accordance with a method of the present invention.

### DETAILED DESCRIPTION

The present invention discloses in one embodiment method and apparatus for classifying an object in a region of interest based on one or more features of the object. Detection and classification of pedestrians, vehicles, and other objects are important, e.g., for automotive safety devices, since these devices may deploy in a particular fashion only if a target of the particular type (i.e., pedestrian or car) is about to be impacted. In particular, measures employed to mitigate the injury to a pedestrian may be very different from those employed to mitigate damage and injury from a vehicle-to-vehicle collision.

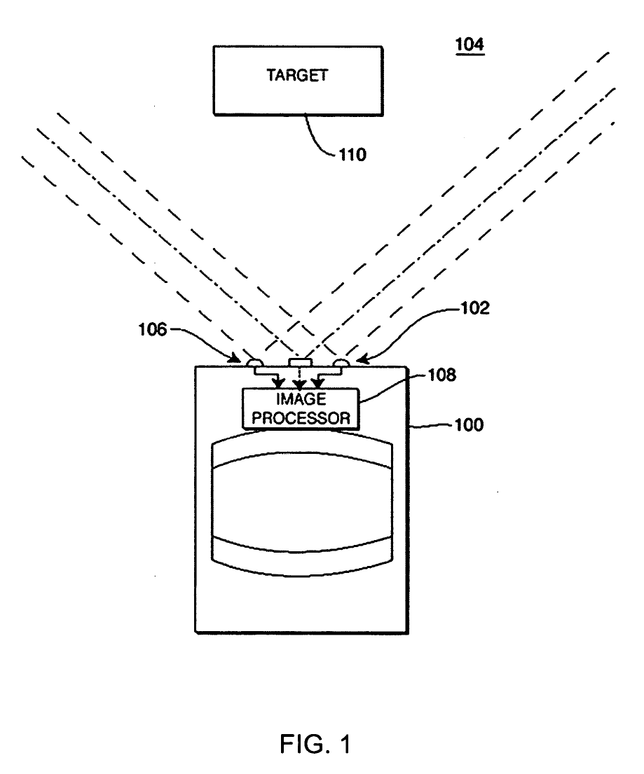

FIG. 1 depicts a schematic diagram of a vehicle 100 having a target differentiation system 102 that differentiates a pedestrian (or pedestrians) 110 within a scene 104 that is proximate the vehicle 100. It should be understood that target differentiation system 102 is operable to detect pedestrians, automobiles, or other objects. While in the illustrated embodiment scene 104 is in front of vehicle 100, other object detection systems may image scenes that are behind or to the side of vehicle 100. Furthermore, target differentiation system 102 need not be related to a vehicle, but can be used with any type of platform, such as a boat, a plane, an elevator, or even stationary streets, docks, or floors. Target differentiation system 102 comprises a sensor array 106 that is coupled to an image processor 108. The sensors within the sensor array 106 have a field of view that includes one or more targets.

The field of view in a practical object detection system 102 may be ±12 meters horizontally in front of the vehicle 100 (e.g., approximately 3 traffic lanes), with a ±3 meter vertical area, and have a view depth of approximately 12-40 meters. (Other fields of view and ranges are possible, depending on camera optics and the particular application.) Therefore, it should be understood that the present invention can be used in a pedestrian detection system or as part of a collision avoidance system.

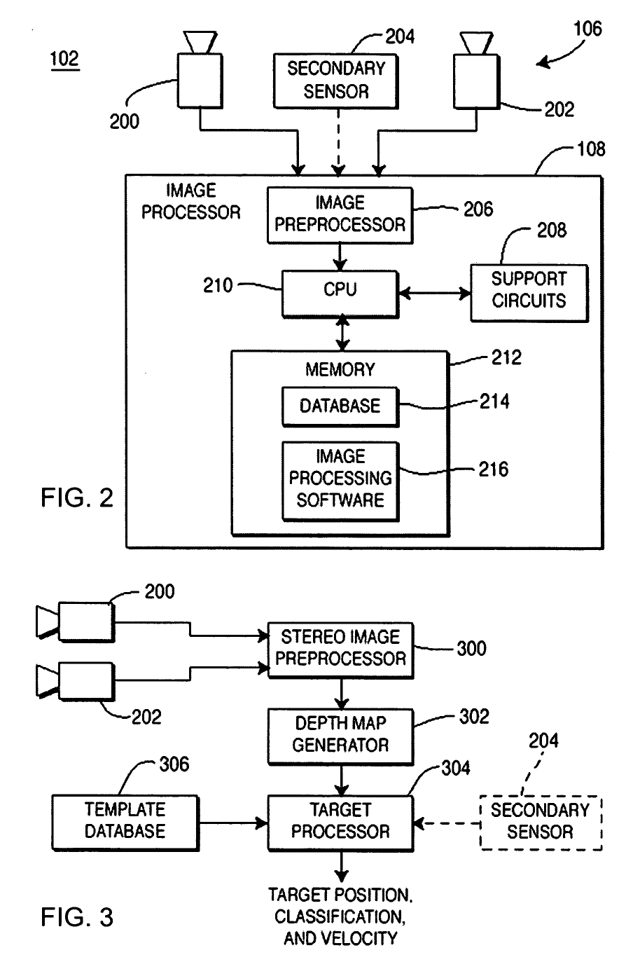

FIG. 2 depicts a block diagram of hardware used to implement the target differentiation system 102. The sensor array 106 comprises, for example, a pair of cameras 200 and 202. In some applications an optional secondary sensor 204 can be included. The secondary sensor 204 may be radar, a light detection and ranging (LIDAR) sensor, an infrared range finder, a sound navigation and ranging (SONAR) senor, and the like. The cameras 200 and 202 generally operate in the visible wavelengths, but may be augmented with infrared sensors, or the cameras may themselves operate in the infrared range. The cameras have a known, fixed relation to one another such that they can produce a stereo image of the scene 104. Therefore, the cameras 200 and 202 will sometimes be referred to herein as stereo cameras.

Still referring to FIG. 2, the image processor 108 comprises an image preprocessor 206, a central processing unit (CPU) 210, support circuits 208, and memory 212. The image preprocessor 206 generally comprises circuitry for capturing, digitizing and processing the imagery from the sensor array 106. The image preprocessor may be a single chip video processor such as the processor manufactured under the model Acadia I™ by Pyramid Vision Technologies of Princeton, N.J.

The processed images from the image preprocessor 206 are coupled to the CPU 210. The CPU 210 may comprise any one of a number of presently available high speed microcontrollers or microprocessors. CPU 210 is supported by support circuits 208 that are generally well known in the art. These circuits include cache, power supplies, clock circuits, input-output circuitry, and the like. Memory 212 is also coupled to CPU 210. Memory 212 stores certain software routines that are retrieved from a storage medium, e.g., an optical disk, and the like, and that are executed by CPU 210 to facilitate operation of the present invention. Memory 212 also stores certain databases 214 of information that are used by the present invention, and image processing software 216 that is used to process the imagery from the sensor array 106. Although the present invention is described in the context of a series of method steps, the method may be performed in hardware, software, or some combination of hardware and software (e.g., an ASIC). Additionally, the methods as disclosed can be stored on a computer readable medium.

FIG. 3 is a functional block diagram of modules that are used to implement the present invention. The stereo cameras 200 and 202 provide stereo imagery to a stereo image preprocessor 300. The stereo image preprocessor is coupled to a depth map generator 302 which is coupled to a target processor 304. Depth map generator 302 may be utilized to define a region of interest (ROI), i.e., an area of the image that potentially contains a target 110. In some applications the depth map generator 302 is not used. In applications where depth map generator 302 is not used, ROIs would be determined using image-based methods. The following will describe the functional block diagrams under the assumption that a depth map generator 302 is used. The target processor 304 receives information from a target template database 306 and from the optional secondary sensor 204. The stereo image preprocessor 300 calibrates the stereo cameras, captures and digitizes imagery, warps the images into alignment, performs pyramid wavelet decomposition, and performs stereo matching, which is generally well known in the art, to create disparity images at different resolutions. In one embodiment, the images are warped using calibration parameters provided by stereo image preprocessor 300.

For both hardware and practical reasons, creating disparity images having different resolutions is beneficial when detecting objects. Calibration provides for a reference point and direction from which all distances and angles are determined. Each of the disparity images contains the point-wise motion from the left image to the right image and each corresponds to a different image resolution. The greater the computed disparity of an imaged object, the closer the object is to the sensor array.

The depth map generator 302 processes the multi-resolution disparity images into a two-dimensional depth image for each of the multi-resolution disparity images. In one embodiment, each depth image is provided using calibration parameters from preprocessor 300. Each depth image (also referred to as a depth map) contains image points or pixels in a two dimensional array, where each point represents a specific distance from the sensor array to a point within scene 104. A depth image at a selected resolution is then processed by the target processor 304 wherein templates (models) of typical objects encountered by the vision system are compared to the information within the depth image. As described below, the template database 306 comprises templates of objects (e.g., automobiles, pedestrians) located at various locations and poses with respect to the sensor array.

An exhaustive search of the template database may be performed to identify the set of templates that most closely explain the present depth image. Secondary sensor 204 may provide additional information regarding the position of the object relative to vehicle 100, velocity of the object, size or angular width of the object, etc., such that the target template search process can be limited to templates of objects at about the known position relative to vehicle 100. Thus, the three-dimensional search space may be limited using secondary sensor 204. Target cueing provided by secondary sensor 204 speeds up processing by limiting the search space to the region to the immediate area of the cued location (e.g., the area indicated by secondary sensor 204) and also improves robustness by eliminating false targets that might otherwise have been considered. If the secondary sensor is a radar sensor, the sensor can, for example, provide an estimate of both object position and distance.

Target processor 304 produces a target list that is then used to identify target size and classification estimates that enable target tracking and the identification of each target's position, classification and velocity within the scene. That information may then be used to avoid collisions with each target or perform pre-crash alterations to the vehicle to mitigate or eliminate damage (e.g., lower or raise the vehicle, deploy air bags, and the like).

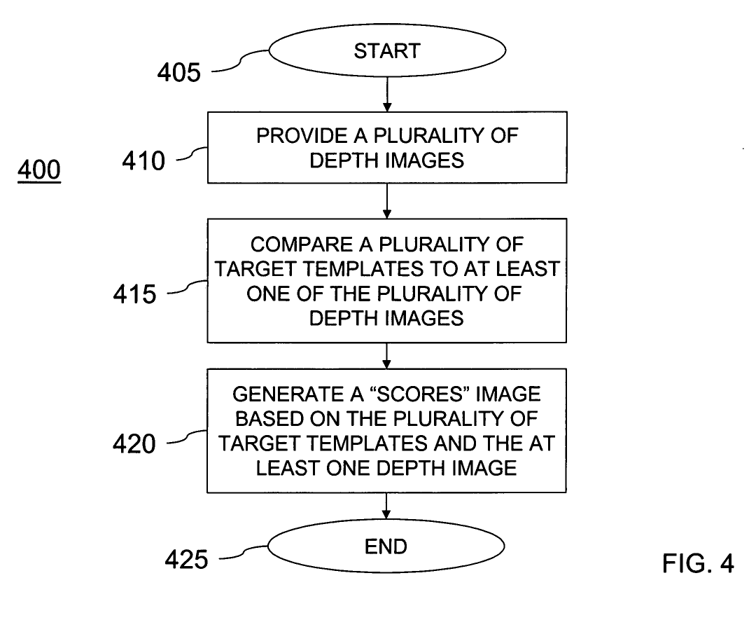

FIG. 4 depicts a flow diagram of a method 400 for detecting a target in an image. The method begins at step 405 and proceeds to step 410. In step 410, a plurality of depth images is provided. Separate depth images are generated by depth map generator 302 for each of the multi-resolution disparity images generated by preprocessor 300.

In step 415, a plurality of target templates is compared to at least one of the plurality of depth images. The plurality of target templates, e.g., “block” templates, may be three-dimensional renderings of vehicle templates, human templates, or templates of other objects. The block templates are rendered at each hypothesized target location within a two-dimensional multiple-lane grid. Previous systems limited detection of target vehicles to a one-dimensional (i.e., a single lane) region adjacent to and behind a host vehicle. The two-dimensional multiple-lane grid of the present invention is tessellated at ¼ meter by ¼ meter resolution in front of a host, e.g., vehicle 100. In other words, at every point in a ¼ meter grid, a three-dimensional pre-rendered template, e.g., vehicle template, human template, or other object template is provided at that location. Then each of the pre-rendered templates is compared to the actual depth image at a particular resolution level. The hypothesized target locations may be determined from the multi-resolution disparity images alone or in conjunction with target cueing information from secondary sensor 204. Multiple resolution depth images are desirable due to camera and lens distortions that occur due to perspective projection for points that are closer to the camera. The distortions that occur when objects are closer to the camera are easier to deal with when using a coarse resolution. In addition, targets which are further away from the camera appear smaller in the camera's images, and thus appear smaller in the multiple resolution depth images, than for targets that are closer to the camera. Finer resolution depth images are therefore generally better able to detect these targets that are further away from the camera.

In one embodiment, a level-2 depth image, e.g., a depth image at a coarse resolution, is used for distances less than or equal to 18 meters and a level-1 depth image is used for distances greater than 18 meters, when searching for vehicles. In one embodiment, the cut-off for level-2 and level-1 depth images may be 12 meters instead of 18 meters, when searching for people. In another embodiment, a level-0 depth image may be used to search for people at distances greater than 30 meters.

In an illustrative example, vehicle detection may be necessary at a distance of 10 meters from host 100. Pre-rendered templates of hypothesized vehicles are provided within a two-dimensional multi-lane grid tessellated at ¼ meter by ¼ meter resolution in front of host 100. The pre-rendered templates are compared to a level-2 depth image since the distance from vehicle 100 is less than 18 meters.

In step 420 a “scores” image based on the plurality of target templates and the at least one depth image is generated. Creating the “scores” image involves searching a template database to match target templates to the depth map. The template database comprises a plurality of pre-rendered templates for targets such as vehicles, and pedestrians, etc.; e.g., depth models of these objects as they would typically be computed by the stereo depth map generator 302. The depth image is a two-dimensional digital image, where each pixel expresses the depth of a visible point in the scene 104 with respect to a known reference coordinate system. As such, the mapping between pixels and corresponding scene points is known. In one embodiment, the template database is populated with multiple vehicle and pedestrian depth models.

A depth model based search is then employed, wherein the search is defined by a set of possible location pose pairs for each model class (e.g., vehicle or pedestrian). For each such pair, the hypothesized 3-D model is rendered and compared with the observed scene 104 range image via a similarity metric. This process creates a “scores” image with dimensionality equal to that of the search space, where each axis represents a model state parameter such as but not limited to lateral or longitudinal distance, and each pixel value expresses a relative measure of the likelihood that a target exists in the scene within the specific parameters. Generally, at this point an exhaustive search is performed wherein a template database is accessed and the templates stored therein are matched to the depth map.

Matching itself can be performed by determining a difference between each of the pixels in the depth image and each similarly positioned pixels in the target template. If the difference at each pixel is less than a predefined amount, the pixel is deemed a match. Individual pixel matching is then used to compute a template match score assigned to corresponding pixels within a scores image where the value (score) is indicative of the probability that the pixel is indicative of the presence of the operative model (e.g., vehicle, pedestrian, or other target).

The match scores may be derived in a number of ways. In one embodiment, the depth differences at each pixel between the template and the depth image are summed across the entire image and normalized by the total number of pixels in the target template. Without loss of generality, these summed depth differences may be inverted or negated to provide a measure of similarity. Spatial and/or temporal filtering of the match score values can be performed to produce new match scores.

In another embodiment, the comparison (difference) at each pixel can be used to determine a yes or no “vote” for that pixel (e.g., vote yes if the depth difference is less than one meter, otherwise vote no). The yes votes can be summed and normalized by the total number of pixels in the template to form a match score for the image.

In another embodiment, the top and bottom halves of the target template are compared to similarly positioned pixels in the depth map. If the difference at each pixel is less than a predefined amount, such as ¼ meter in the case of a pedestrian template and 1 meter in the case of a vehicle template, the pixel is deemed a first match. The number of pixels deemed a first match is then summed and then divided by the total number of pixels in the first half of the target template to produce a first match score. Then, the difference of each of the pixels in the second half of the depth image and each similarly positioned pixel in the second half of the target template are determined. If the difference at each pixel is less than a predefined amount, the pixel is deemed a second match. The total number of pixels deemed a second match is then divided by the total number of pixels in the second half of the template to produce a second match score. The first match score and the second match score are then multiplied to determine a final match score.

The scores image is then used to provide target aggregation from match scores. In one embodiment, a mean-shift algorithm is used to detect and localize specific targets from the scores image.

Once specific targets, e.g., vehicles, humans, and/or other objects, are detected and localized, a target list is generated. In one embodiment, radar validation of detected targets may optionally be performed. The detection of a vision target using radar increases confidence in the original target detection. Using radar guards against “false positives”, i.e., false identification of a target.

Target size and classification may be estimated for each detected target. Depth, depth variance, edge, and texture information may be used to determine target height and width, and classify targets into categories (e.g., sedan, sport utility vehicle (SUV), truck, pedestrian, pole, wall, motorcycle).

Characteristics (e.g., location, classification, height, width) of targets may be tracked using Kalman filters. Some targets may be rejected if these targets don't track well. Position, classification, and velocity of tracked targets may be output to other modules, such as another personal computer (PC) or sensor, using appropriate communication formats.

While the foregoing is directed to embodiments of the present invention, other and further embodiments of the invention may be devised without departing from the basic scope thereof, and the scope thereof is determined by the claims that follow.

1. A method of detecting a target in an image, comprising:
providing a plurality of depth images;
comparing a plurality of target templates to at least one of the plurality of depth images; and
generating a scores image based on said plurality of target templates and said at least one depth image.

2. The method of claim 1, wherein target templates are rendered at hypothesized target locations within a two-dimensional multiple lane grid in front of a host.

3. The method of claim 2, wherein the two-dimensional multiple lane grid is tessellated at ¼ meter by ¼ meter resolution.

4. The method of claim 2, wherein the target templates comprise vehicle templates.

5. The method of claim 2, wherein the target templates comprise human templates.

6. The method of claim 1, wherein providing said plurality of depth images comprises generating a separate depth image for each of a plurality of multiple resolution disparity images.

7. The method of claim 1, wherein said at least one depth image is selected according to a distance of a target template from a host.

8. An apparatus for detecting a target in an image, comprising:
means for providing a plurality of depth images;
means for comparing a plurality of target templates to at least one of the plurality of depth images; and
means for generating a scores image based on said plurality of target templates and said at least one depth image.

9. The apparatus of claim 8, wherein target templates are rendered at hypothesized target locations within a two-dimensional multiple lane grid in front of a host.

10. The apparatus of claim 9, wherein the two-dimensional multiple lane grid is tessellated at ¼ meter by ¼ meter resolution.

11. The apparatus of claim 9, wherein the target templates comprise vehicle templates.

12. The apparatus of claim 9, wherein the target templates comprise human templates.

13. The apparatus of claim 8, wherein providing said plurality of depth images comprises generating a separate depth image for each of a plurality of multiple resolution disparity images.

14. The apparatus of claim 8, wherein said at least one depth image is selected according to a distance of a target template from a host.

15. A computer-readable medium having stored thereon a plurality of instructions, the plurality of instructions including instructions which, when executed by a processor, cause the processor to perform the steps of a method of detecting a target in an image, comprising:
providing a plurality of depth images;
comparing a plurality of target templates to at least one of the plurality of depth images; and
generating a scores image based on said plurality of target templates and said at least one depth image.

16. The computer readable medium of claim 15, wherein target templates are rendered at hypothesized target locations within a two-dimensional multiple lane grid in front of a host.

17. The computer readable medium of claim 16, wherein the two-dimensional multiple lane grid is tessellated at ¼ meter by ¼ meter resolution.

18. The computer readable medium of claim 16, wherein the target templates comprise vehicle templates.

19. The computer readable medium of claim 15, wherein providing said plurality of depth images comprises generating a separate depth image for each of a plurality of multiple resolution disparity images.

20. The computer readable medium of claim 15, wherein said at least one depth image is selected according to a distance of a target template from a host.
